(19) United States
(12) Patent Application Publication
(10) Pub. No.: US 2024/0253681 A1
(43) Pub. Date: Aug. 1, 2024

(54) CART ASSEMBLY

(71) Applicant: Timothy Osmon, Searcy, AR (US)

(72) Inventor: Timothy Osmon, Searcy, AR (US)

(21) Appl. No.: 18/101,730

(22) Filed: Jan. 26, 2023

(51) Int. Cl. B62B 3/10; B62B 3/00; B62B 3/02

(52) U.S. Cl. CPC B62B 3/10; B62B 3/002; B62B 3/025

(57) ABSTRACT

A cart assembly for movably storing items includes a wagon comprising a body and a plurality of wheels extending downwardly from the body. Each one of a pair of brackets is coupled to one of a front side and a rear side of the body of the wagon. Each one of a pair of support rods is coupled to and extends upwardly from one of the pair of brackets. A hanger beam is coupled to and extends between each support rod. The hanger beam comprises a crossbar and a plurality of hooks. The crossbar has a front end and a rear end, and the crossbar extends between each support rod. Each hook is coupled to and extends downwardly from the crossbar.

### BACKGROUND OF THE INVENTION

### (1) Field of the Invention

The disclosure relates to cart assemblies and more particularly pertains to a new cart assembly for movably storing items.

### (2) Description of Related Art Including Information Disclosed Under 37 CFR 1.97 and 1.98

The prior art relates to cart assemblies which are towed by a user and which carry items within them or on a hanging rack. These include myriad wagons which have linkages for folding or collapsing the wagon for storage and wagons which have flexible side walls. The prior art fails to address a wagon or cart having a pair of brackets that mount to a front end and a back end of a body of the wagon, detachable collapsible vertical posts for connecting to each of the brackets, and a horizontal top bar which detachably couples to the pair of vertical posts and has a plurality of hooks for hanging objects.

### Brief Summary of the Invention

An embodiment of the disclosure meets the needs presented above by generally comprising a wagon comprising a body and a plurality of wheels extending downwardly from the body. Each one of a pair of brackets is coupled to one of a front side and a rear side of the body of the wagon. Each one of a pair of support rods is coupled to and extends upwardly from one of the pair of brackets. A hanger beam is coupled to and extends between each support rod. The hanger beam comprises a crossbar and a plurality of hooks. The crossbar has a front end and a rear end, and the crossbar extends between each support rod. Each hook is coupled to and extends downwardly from the crossbar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a cart assembly according to an embodiment of the disclosure.

FIG. 2 is a front view of an embodiment of the disclosure.

FIG. 3 is a perspective in-use view of an embodiment of the disclosure.

FIG. 4 is a bottom front side perspective exploded view of an embodiment of the disclosure.

FIG. 5 is a detail cross-section view of a support rod according to an embodiment of the disclosure from Arrows 5-5 in FIG. 2.

FIG. 6 is a detail cross-section view of a crossbar according to an embodiment of the disclosure from Arrows 6-6 in FIG. 1.

FIG. 7 is a detail perspective view of a bracket according to an embodiment of the disclosure.

FIG. 8 is a detail perspective view of a bracket according to an embodiment of the disclosure.

FIG. 9 is an exploded view of an embodiment of the disclosure.

FIG. 10 is an in-use exploded view of an embodiment of the disclosure.

FIG. 11 is a top rear side perspective view of an embodiment of the disclosure.

### DETAILED DESCRIPTION OF THE INVENTION

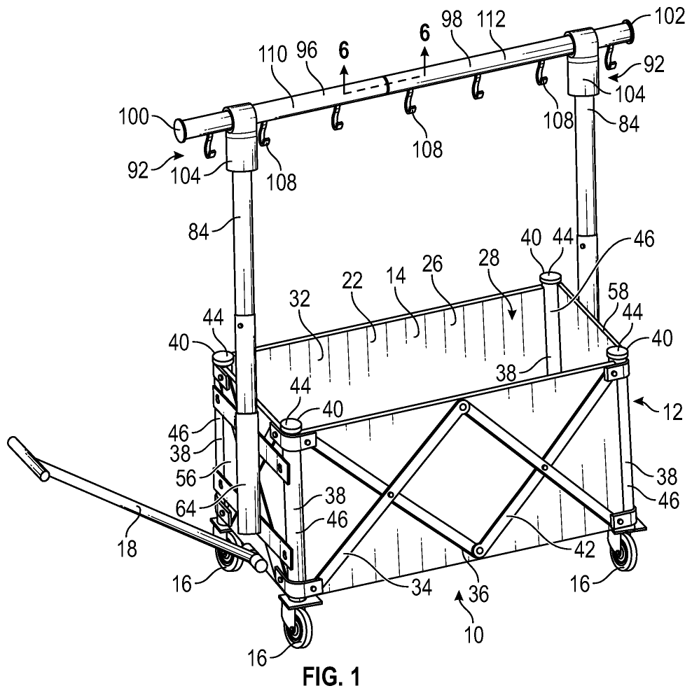

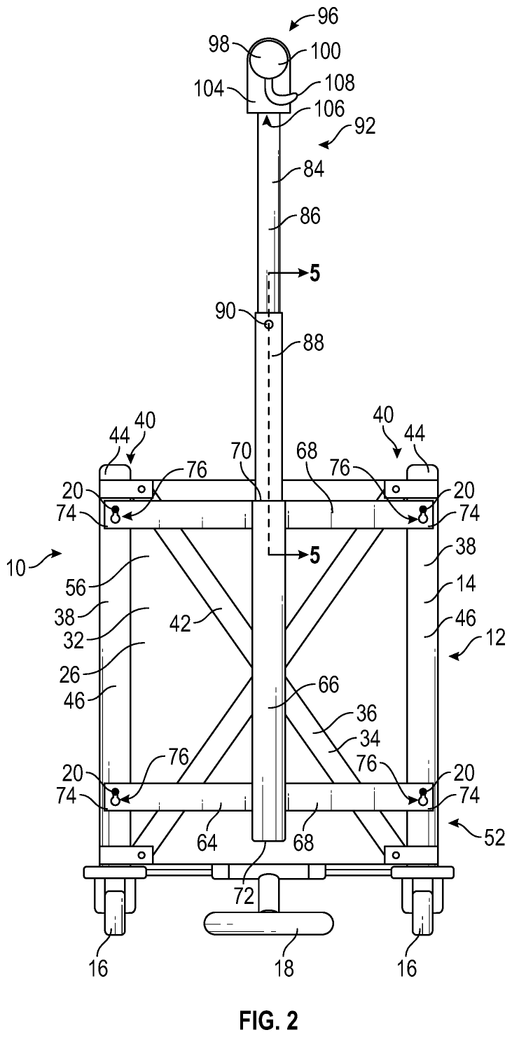

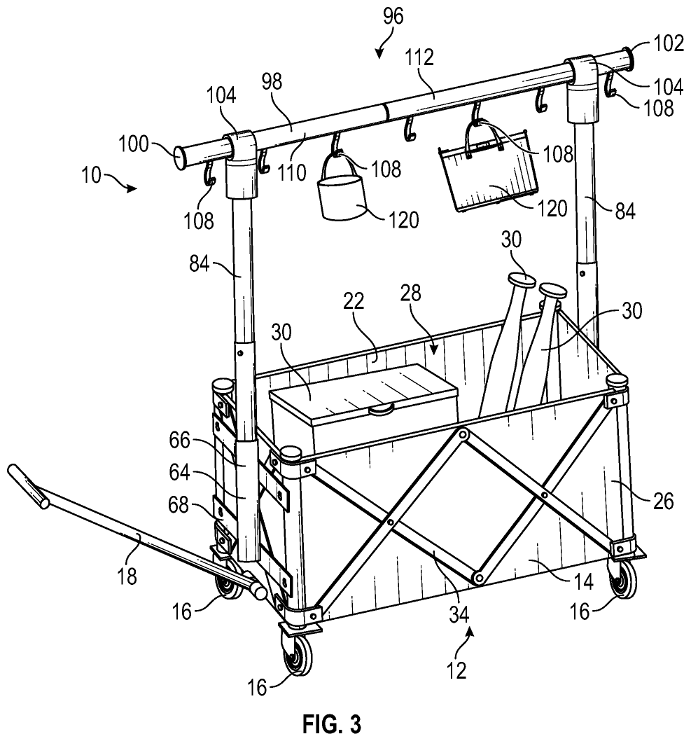

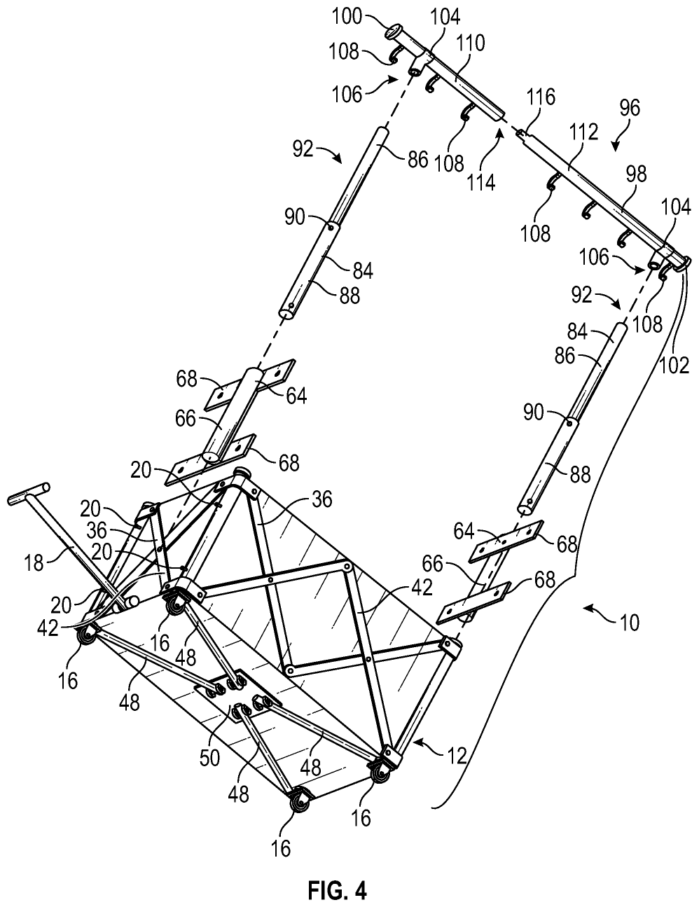

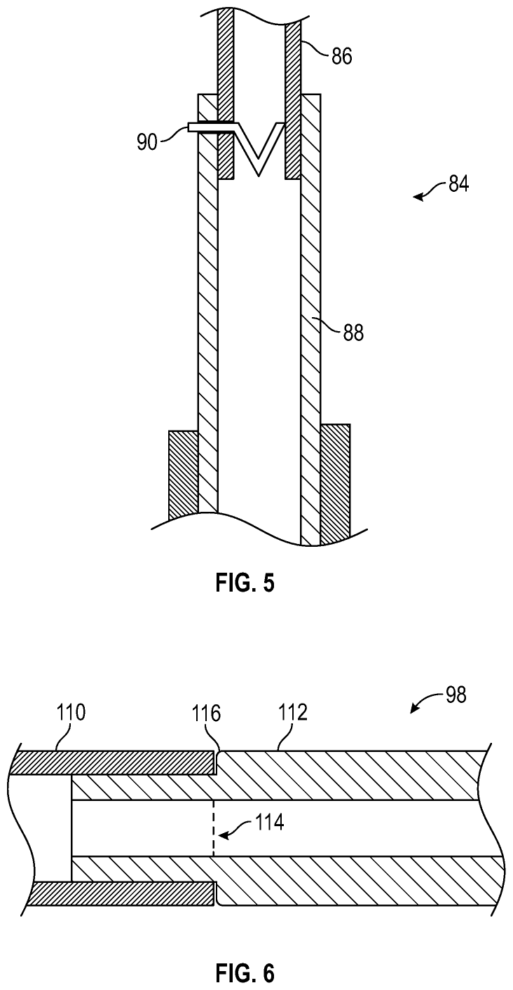

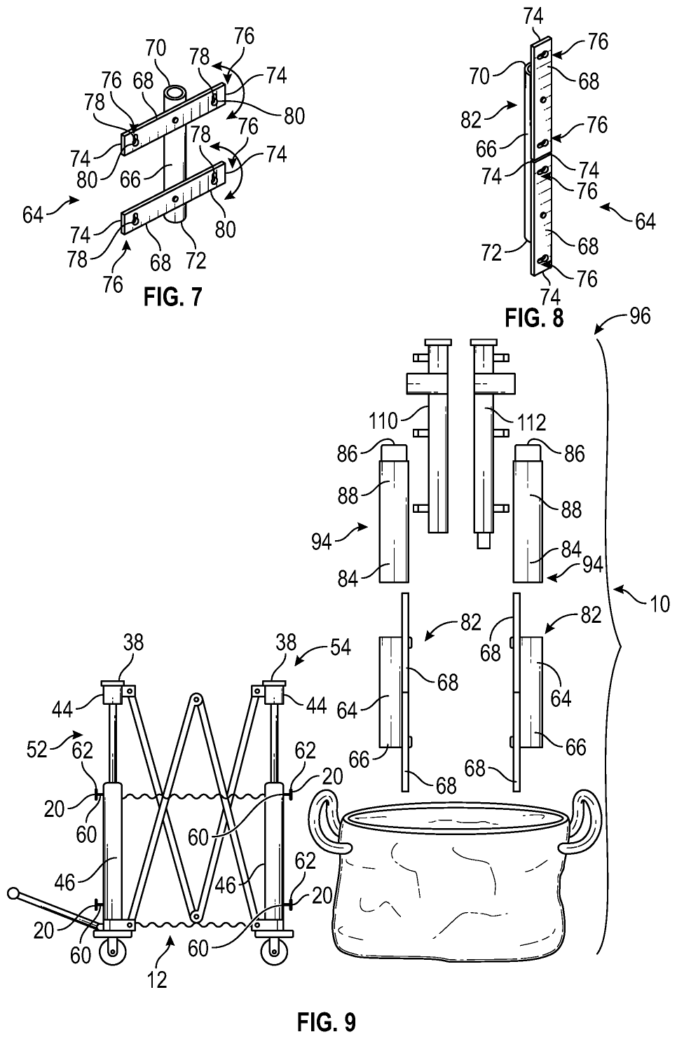

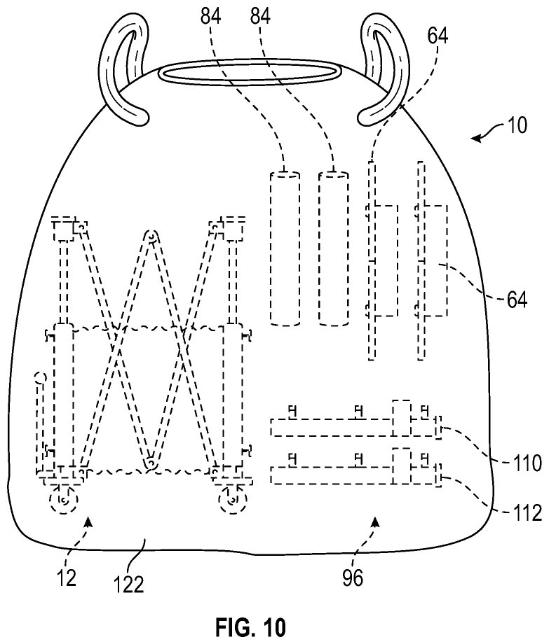

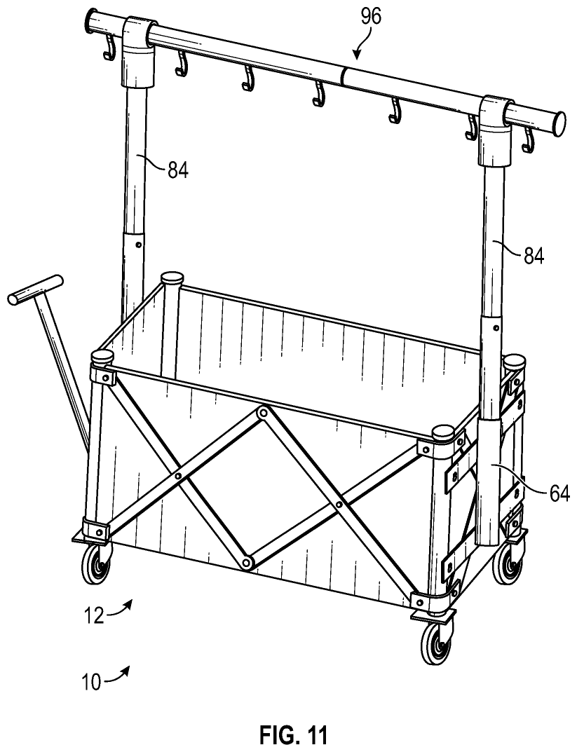

With reference now to the drawings, and in particular to FIGS. 1 through 11 thereof, a new cart assembly embodying the principles and concepts of an embodiment of the disclosure and generally designated by the reference numeral 10 will be described.

As best illustrated in FIGS. 1 through 10, the cart assembly 11 generally comprises a wagon 12 comprising a body 14, a plurality of wheels 16, a handle 18, and a plurality of pegs 20. The body 14 includes a container 22 has a bottom wall 24 and a perimeter wall 26, where the perimeter wall 26 extends upwardly from the bottom wall 24. The container 22 defines a cavity 28 bounded by the bottom wall 24 and the perimeter wall 26 for storing items 30. The bottom wall 24 and the perimeter wall 26 are flexible and may comprise a fabric 32. The body 14 also includes a frame 34 which is coupled to and surrounds the container 22 to support the container 22. The frame 34 also comprises a plurality of linkages 36 for collapsing the body 14 of the wagon 12.

In one embodiment, for example, the frame 34 has a plurality of telescopic vertical supports 38 in four corners 40 of the body 14 with scissor linkages 42 extending along the outside of the container 22 and between each consecutive pair of the plurality of telescopic vertical supports 38. Each scissor linkage 42 in this embodiment is coupled to upper 44 and lower segments 46 of the consecutive pair of telescopic vertical supports 38 such that each one of the two telescopic vertical supports 38 extends when the two telescopic vertical supports 38 are moved toward each other. In this configuration, the telescopic vertical supports 38 move toward each other when the upper segments 44 are extended away from the lower segments 46. This embodiment may also have a plurality of pivoting members 48 which each extend from each telescopic vertical support 38 underneath the bottom wall 24 to a central member 50. Each pivoting member 48 is pivotally coupled to an associated one of the plurality of telescopic vertical supports 38 and pivotally coupled to the central member 50 such that when the central member 50 is moved upwardly, the telescopic vertical supports 38 are moved toward each other.

Each wheel 16 extends downwardly from the body 14, and the handle 18 is pivotably coupled to the body 14. The handle 18 extends forwardly from the body 14 such that the handle 18 is pivotable upwardly and downwardly. The plurality of pegs 20 includes a front set 52 of pegs 20 and a rear set 54 of peg 20. Each one of the front set 52 of pegs 20 is coupled to and extends forwardly from a front side 56 of the body 14, while each one of the rear set 54 of pegs 20 is coupled to and extends rearwardly from a rear side 58 of the body 14. Each peg 20 has a neck 60 and a head 62, and a width of the head 62 is greater than a width of the neck 60.

Each one of a pair of brackets 64 is coupled to one of the front side 56 and the rear side 58 of the body 14 of the wagon 12. Each bracket 64 comprises a tube 66 and a pair of attachment arms 68. The tube 66 is elongated and has an open top end 70 and a closed bottom end 72. Each attachment arm 68 is coupled to the tube 66 and extends laterally with respect to the tube 66. One of the attachment arms 68 is positioned vertically above another of the attachment arms 68, and the tube 66 is centered between a pair of ends 74 of each attachment arm 68. Each attachment arm 68 has a pair of holes 76 extending through an associated one of the attachment arms 68 and is positioned adjacent to one of the pair of ends 74 of the associated attachment arm 68. Each hole 76 has a top portion 78 and a bottom portion 80. The bottom portion 80 is wider than the top portion 78 such that the head 62 of one of the pegs 20 is insertable through the bottom portion 80 and engageable with the associated attachment arm 68 adjacent to the top portion 78 to removably attach the bracket 64 to the wagon 12. Each attachment arm 68 is rotatably coupled to the tube 66 such that the bracket 64 is positionable in a collapsed configuration 82 comprising each attachment arm 68 being oriented to extend parallel to the tube 66 between said pair of ends 74. One of the ends 74 of one of the attachment arms 68 is also positioned adjacent to one of the ends 74 of another of the attachment arms 68 when the bracket 64 is positioned in the collapsed configuration 82.

Each one of a pair of support rods 84 is positioned within and extending upwardly from an associated one of the tubes 66. Each support rod 84 is removable from the associated tube 66 and is collapsible. Each support rod 84 comprises a first rod segment 86 and a second rod segment 88 telescopically received into the first rod segment 86. A securement button 90 is coupled to the second rod segment 88 and is biased to extend through and engage the first rod segment 86 to secure the support rod 84 in one of an extended position 92 and a retracted position 94.

A hanger beam 96 is coupled to and extends between each support rod 84. The hanger beam 96 is also removable from each support rod 84. The hanger beam 96 comprises a crossbar 98 having a front end 100 and a rear end 102 which extends between each support rod 84. Each one of pair of holders 104 is coupled to and extends downwardly from the crossbar 98. Each holder 104 has a socket 106 extending upwardly into an associated one of the pair of holders 104 for removably receiving one of the pair of support rods 84. Each holder 104 is spaced between the front end 100 and the rear end 102. Each one of a plurality of hooks 108 is coupled to and extends downwardly from the crossbar 98. Each hook 108 curves laterally with respect to the hanger beam 96. One of the hooks 108 is positioned between the front end 100 and one of the holders 104, while another of the hooks 108 is positioned between the rear end 102 and another of the holders 104. The crossbar 98 comprises a front bar segment 110 and a rear bar segment 112 which are removably coupled to each other. The rear bar segment 112 is received into an opening 114 of the front bar segment 110. The front bar segment 110 and the rear bar segment 112 may have a same outer width measured transversely to a line extending from the front end 100 of the cross bar to the rear end 102. The rear bar segment 112 may have a shoulder 116 formed for abutting the front bar segment 110 when being received into the opening 114. The front bar segment 110 and the rear bar segment 112 may be retained relative to each other by frictional engagement, a clamp, set screw, spring-biased button, or the like. Each of the front bar segment 110 and the rear bar segment 112 is coupled to one of the pair of holders 104.

In use, the items 30 are stored in the cavity 28 formed by the container 22. Hangable objects 120 may be hung onto the hooks 108. Then the wagon 12 can be moved along a surface via the wheels 16 to move the items 30 and the hangable objects 120. To store the cart assembly 10, the hanger beam 96 is removed from the pair of support rods 84, and the front bar segment 110 and the rear bar segment 112 are removed from each other. Each support rod 84 is removed from the tube 66 of one of the brackets 64 and positioned in the retracted position 94. Each bracket 64 is removed from the wagon 12 and positioned in a collapsed configuration 82. The wagon 12 is also collapsed. Then the hanger beam 96, the pair of support rods 84, the pair of brackets 64, and the wagon 12, are placed in a bag 122.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cart assembly comprising:
a wagon comprising a body and a plurality of wheels extending downwardly from said body;
a pair of brackets, each bracket being coupled to one of a front side and a rear side of said body of said wagon;
a pair of support rods, each support rod being coupled to and extending upwardly from one of said pair of brackets;
a hanger beam being coupled to and extending between each support rod, said hanger beam comprising:
a crossbar having a front end and a rear end, said crossbar extending between each support rod; and
a plurality of hooks, each hook being coupled to and extending downwardly from said crossbar.

2. The assembly of claim 1, wherein said body of said wagon comprises a container having a bottom wall and a perimeter wall, said perimeter wall extending upwardly from said bottom wall, said container defining a cavity bounded by said bottom wall and said perimeter wall for storing items.

3. The assembly of claim 2, wherein said bottom wall and said perimeter wall are flexible.

4. The assembly of claim 2, wherein said body further comprises a frame being coupled to and surrounding said container for supporting said container, said frame comprising a plurality of linkages for collapsing said body of said wagon.

5. The assembly of claim 1, wherein said wagon further comprises a handle being pivotally coupled to and extending forwardly from said body such that said handle is pivotable upwardly and downwardly.

6. The assembly of claim 1, wherein each bracket is removable from said wagon.

7. The assembly of claim 6, wherein:
said wagon further comprises a plurality of pegs, said plurality of pegs including a front set of pegs and a rear set of pegs, each peg of said front set of pegs being coupled to and extending forwardly from a front side of said body, each peg of said rear set of pegs being coupled to and extending rearwardly from a rear side of said body; and
each bracket comprises:
a tube being elongated and having an open top end and a closed bottom end; and
a pair of attachment arms, each attachment arm being coupled to said tube and extending laterally with respect to said tube, one of said attachment arms being positioned vertically above another of said attachment arms, each attachment arm having a pair of holes extending through an associated one of said attachment arms and being positioned adjacent to one of a pair of ends of said associated attachment arm, wherein each peg is insertable through one of said pair of holes and engageable with said associated attachment arm to removably attach said bracket to said wagon.

8. The assembly of claim 7, wherein:
each peg has a neck and a head, a width of said head being greater than a width of said neck; and
each hole of each attachment arm has a top portion and a bottom portion being wider than said top portion such that said head of one of said pegs is insertable through said bottom portion and engageable with an associated one of said pair of attachment arms adjacent to said top portion to removably attach said bracket associated with said associated attachment arm to said wagon.

9. The assembly of claim 7, wherein each attachment arm is rotatably coupled to said tube of an associated bracket of said pair of brackets such that said associated bracket is positionable in a collapsed configuration, said collapsed configuration comprising each attachment arm being oriented to extend parallel to said tube, one of said ends of one of said attachment arms being positioned adjacent to one of said ends of another of said attachment arms when said bracket is positioned in said collapsed configuration.

10. The assembly of claim 7, wherein said tube of an associated bracket of said pair of brackets is centered between said pair of ends of each attachment arm of said associated bracket.

11. The assembly of claim 7, wherein each support rod is positioned within and extending upwardly from an associated one of said tubes.

12. The assembly of claim 1, wherein each support rod is collapsible.

13. The assembly of claim 12, wherein each support rod comprises:
a first rod segment; and
a second rod segment being telescopically received into said first rod segment.

14. The assembly of claim 13, wherein each support rod further comprises a securement button being coupled to said second rod segment and being biased to extend through and engage said first rod segment to secure said support rod in one of an extended position and a retracted position.

15. The assembly of claim 1, wherein said hanger beam is removable from each support rod.

16. The assembly of claim 15, wherein said hanger beam comprises a pair of holders, each holder being coupled to and extending downwardly from said crossbar, each holder having a socket extending upwardly into an associated one of said pair of holders, said socket of each holder removably receiving one of said pair of support rods.

17. The assembly of claim 16, wherein said crossbar comprises a front bar segment and a rear bar segment being removably coupled to each other, said rear bar segment being received into an opening of said front bar segment, each of said front bar segment and said rear bar segment being coupled to one of said pair of holders.

18. The assembly of claim 1, wherein each hook curves laterally with respect to said hanger beam.

19. The assembly of claim 1, wherein one of said hooks is positioned between said front end and one of said holders, another of said hooks being positioned between said rear end and another of said holders.

20. A cart assembly comprising:
a wagon comprising:
a body comprising:
a container comprising a bottom wall and a perimeter wall, said perimeter wall extending upwardly from said bottom wall, said container defining a cavity bounded by said bottom wall and said perimeter wall for storing items, said bottom wall and said perimeter wall being flexible; and
a frame being coupled to and surrounding said container for supporting said container, said frame comprising a plurality of linkages for collapsing said body of said wagon;
a plurality of wheels extending downwardly from said body;
a handle being pivotally coupled to and extending forwardly from said body such that said handle is pivotable upwardly and downwardly; and
a plurality of pegs, each peg having a neck and a head, a width of said head being greater than a width of said neck, said plurality of pegs including a front set of pegs and a rear set of pegs, each peg of said front set of pegs being coupled to and extending forwardly from a front side of said body, each peg of said rear set of pegs being coupled to and extending rearwardly from a rear side of said body;
a pair of brackets, each bracket being coupled to one of said front side and said rear side of said body of said wagon, each bracket comprising:
a tube being elongated and having an open top end and a closed bottom end; and
a pair of attachment arms, each attachment arm being coupled to said tube and extending laterally with respect to said tube, one of said attachment arms being positioned vertically above another of said attachment arms, said tube being centered between a pair of ends of each attachment arm, each attachment arm having a pair of holes extending through an associated one of said attachment arms and being positioned adjacent to one of said pair of ends of said associated attachment arm, each hole having a top portion and a bottom portion being wider than said top portion such that said head of one of said pegs is insertable through said bottom portion and engageable with said associated attachment arm adjacent to said top portion to removably attach said bracket to said wagon, each attachment arm being rotatably coupled to said tube such that said bracket is positionable in a collapsed configuration, said collapsed configuration comprising each attachment arm being oriented to extend parallel to said tube, one of said ends of one of said attachment arms being positioned adjacent to one of said ends of another of said attachment arms when said bracket is positioned in said collapsed configuration;
a pair of support rods, each support rod being positioned within and extending upwardly from an associated one of said tubes, each support rod being removable from said associated tube, each support rod being collapsible, each support rod comprising:
a first rod segment;
a second rod segment being telescopically received into said first rod segment; and
a securement button being coupled to said second rod segment and being biased to extend through and engage said first rod segment to secure said support rod in one of an extended position and a retracted position; and
a hanger beam being coupled to and extending between each support rod, said hanger beam being removable from each support rod, said hanger beam comprising:
a crossbar having a front end and a rear end, said crossbar extending between each support rod;
a pair of holders, each holder being coupled to and extending downwardly from said crossbar, each holder having a socket extending upwardly into an associated one of said pair of holders, said socket of each holder removably receiving one of said pair of support rods, each holder being spaced between said front end and said rear end;
a plurality of hooks, each hook being coupled to and extending downwardly from said crossbar, each hook curving laterally with respect to said hanger beam, one of said hooks being positioned between said front end and one of said holders, another of said hooks being positioned between said rear end and another of said holders; and
said crossbar comprising a front bar segment and a rear bar segment being removably coupled to each other, said rear bar segment being received into an opening of said front bar segment, each of said front bar segment and said rear bar segment being coupled to one of said pair of holders.
